(19) United States
(12) Patent Application Publication
(10) Pub. No.: US 2010/0012845 A1
(43) Pub. Date: Jan. 21, 2010

(54) ENERGY-RESOLVING DETECTION SYSTEM AND IMAGING SYSTEM

(75) Inventors: Christian Baeumer, Aachen (DE); Guenter Zeitler, Aachen (DE); Christoph Herrmann, Aachen (DE); Roger Steadman Booker, Aachen (DE); Klaus Jurgen Engel, Aachen (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/520,221

(22) PCT Filed: Dec. 17, 2007
(86) PCT No.: PCT/IB07/55149

§ 371 Date: Jun. 19, 2009

(30) Foreign Application Priority Data
Dec. 22, 2006 (EP) 06127048.4

(51) Int. Cl. G01T 1/36; G01T 1/20; G01T 1/24

(52) U.S. Cl. 250/361 R; 250/370.08; 250/370.14

(57) ABSTRACT

The invention relates to an energy-resolving detection system for detecting radiation (4). The energy-resolving detection system comprises a first layer (21) for absorbing a part of the radiation (4) and a radiation quanta counting unit comprising a second layer (26) for counting radiation quanta of the radiation (4). A read-out unit (29) is coupled with the radiation quanta counting unit for reading out the radiation quanta counting unit. The first layer (21) and second layer (26) are arranged such that the radiation (4), which is incident on the detection system and which reaches the second layer (26), has passed the first layer (21).

### FIELD OF THE INVENTION

The invention relates to an energy-resolving detection system for detecting radiation, an imaging system comprising the energy-resolving detection system and a method for producing an energy-resolving detection system.

### BACKGROUND OF THE INVENTION

Energy-resolving detection systems can, for example, be used for spectral computed tomography (spectral CT), wherein an object, which has to be reconstructed, is illuminated with a spectrum of radiation, in particular a spectrum of X-ray radiation, and wherein the radiation after having passed the object is detected by an energy-resolving detection system, which is adapted for detecting radiation energy-resolved.

V. B. Cajipe et al. disclose in “Multi-Energy X-ray Imaging with Linear CZT Pixel Arrays and Integrated Electronics,” 14th Intl. Workshop on Room-Temperature Semiconductor X-Ray and Gamma-Ray Detectors, Rome, Italy, Oct. 18-22, 2004 an energy-resolving detection system, which uses cadmium zinc telluride (CZT) being a direct-conversion material, which directly converts incident radiation into electrical signals, and an application specific integrated circuit (ASIC) as a read-out unit for reading out the electrical signals generated in the CZT. This known energy-resolving detection system has the drawback that it can only cope with a limited range of intensities of the radiation. If the intensity (count rate) is above a certain intensity value, this energy-resolving detection system cannot distinguish between different radiation quanta, in particular X-ray photons, impinging on the energy-resolving detection system, i.e. the detection signals are superimposed signals of several radiation quanta, resulting in a wrong energy measurement leading to a decreased energy resolution of the energy-resolving detection system. X-ray intensities, which are used in a CT system, are far above the mentioned certain intensity value so that the detection system cannot be operated in a photon-counting mode and that the detection signals generated by the energy-resolving detection system are superimposed signals, which do not provide any energy resolution. This reduced or inexistent energy resolution of the detection signals causes artefacts in images, which have been reconstructed by a spectral CT system.

### SUMMARY OF THE INVENTION

It is therefore an object of the invention to provide an energy-resolving detection system having an improved energy resolution. It is a further object of the invention to provide a corresponding imaging system.

In an aspect of the present invention, an energy-resolving detection system for detecting radiation is presented, which comprises

a first layer for absorbing a part of the radiation,

a radiation quanta counting unit comprising a second layer for counting radiation quanta of the radiation,

a read-out unit coupled with the radiation quanta counting unit for reading out the radiation quanta counting unit,

wherein the first layer and the second layer are arranged such that the radiation, which is incident on the detection system and which reaches the second layer, has passed the first layer.

The invention is based on the idea that, since the radiation reaching the second layer has been partly absorbed by passing the first layer, the intensity of the radiation reaching the second layer has been reduced, diminishing the effect of superimposing of several radiation quanta and, thus, increasing the energy resolution of the energy-resolving detection system.

The first layer comprises preferentially an absorbing material. An absorbing material is, for example, a converting material, which converts radiation into optical photons, like a scintillation material.

It is preferred that the second layer comprises a direct conversion material for converting radiation into electrical signals and that the read-out unit is coupled with the second layer for reading out the second layer by reading out the electrical signals of the second layer. This allows counting of radiation quanta in a reliable way.

The direct conversion material is preferentially coupled with counting channels of the read-out unit. The read-out unit is preferentially adapted to assign each radiation quanta to a predetermined energy window, wherein the radiation quanta of each energy window are counted. Preferentially the read-out unit provides at least two energy windows.

It is preferred that the first layer comprises a scintillator material and that the energy-resolving detection system further comprises a light detection unit for detecting light, in particular optical photons, generated in the first layer. This allows detecting also the radiation, which has been absorbed by the first layer, wherein the whole radiation incident on the energy-resolving detection system is used by the energy-resolving detection system increasing the signal-to-noise ratio.

The scintillator material is, for example, gadolinium oxide sulfide (GOS), in particular doped with for example praseodymium (Pr), and the light detection unit is preferentially a photodiode.

It is further preferred that the light detection unit is arranged for detecting light generated in the first layer in a direction perpendicular to a direction of incidence of the radiation. This reduces direct conversion in the light detection unit, wherein scintillation photons are sensed from the side.

It is further preferred that the light detection unit is shielded by a shield for reducing direct detection of the radiation incident on the detection system by the light detection unit. The light detection unit is preferentially shielded by a shield made of a high-Z metal, i.e. a metal having an atomic number Z, which is large enough for shielding the light detection unit from the incident radiation. Preferentially, the atomic number is larger than 30. It is further preferred that the atomic number is larger than 40. At least one of tungsten, lead and molybdenum is preferentially used for shielding the light detection unit. The shield is preferentially located on the side of the light detection unit, which is arranged in the direction of the incident radiation.

In an embodiment, the energy-resolving detection system comprises a voltage unit, which is coupled with a first surface of the second layer facing the first layer, for setting the first surface of the second layer to a negative voltage. For coupling the surface of the second light layer facing the first layer with the voltage unit, preferentially a metal electrode is used. In addition, this metal electrode preferentially prevents photons, in particular optical photons but also K-fluorescence photons, of the first layer to react misleadingly in the second layer. The metal of the electrode is preferentially chosen such that it is suitable for contacting the direct-conversion material. The electrode can comprise one or more metals. Preferentially, the electrode comprises at least one of platinum, indium and gold, especially if the direct-conversion material is CdZnTe (also referred to as CZT) or another CdTe-type material. A CdTe-type material comprises, for example, cadmium, tellurium and preferentially further elements. A CdTe-type material is, for example, CdTe or CdMnTe. Also other 11-VI semiconductors and ITT-V semiconductors can be used as conversion material of the second layer. The metal electrode is preferentially thin, i.e. it has preferentially a thickness smaller than 10 μm, further preferred smaller than 1 μm, further preferred smaller than 500 nm, and preferentially the metal electrode has a thickness of 100 nm. It is also preferred, that the metal electrode comprises a layer of one of the metals platinum, indium and gold, wherein the thickness of this layer is preferentially smaller than 10 μm, further preferred smaller than 1 μm, further preferred smaller than 500 nm, and it is further preferred that the thickness of this layer is 100 nm. The negative voltage at the surface of the second layer facing the first layer forces electrons generated in the second layer in the direction of the coupling with the read-out unit, in order to improve the read out the electrical signals of the second layer.

In another embodiment, the energy-resolving detection system can comprise a voltage unit, which is coupled with a first surface of the second layer facing the first layer, for setting the first surface of the second layer to a positive voltage, in particular if the second layer comprises silicon. The positive voltage at the surface of the second layer facing the first layer forces holes generated in the second layer in the direction of the coupling with the read-out unit, in order to improve the read out of the electrical signals of the second layer.

It is further preferred, that a second surface of the second layer, which is opposed to a first surface of the second layer facing the first layer, is coupled to a plurality of electrodes, wherein each electrode is coupled with the read-out unit such that the electrodes can be read out independently from each other. Since the electrodes can be read out independently from each other, the spatial resolution of the energy-resolving detection system can be improved. Furthermore, the count rate of each electrode is reduced with respect to the count rate of an electrode covering the whole second surface of the second layer allowing to use cost effective state-of-the-art counting electronics.

Furthermore, such a use of a plurality of electrodes for coupling with, in particular contacting, the second surface of the second layer allows a sub-pixellation, wherein the aspect ratio (thickness to pixel size) of the second layer can be adjusted such that the so called “small pixel effect” can be used beneficially to improve the performance of the energy-resolving detection system. The electrodes coupled with the second surface of the second layer are preferentially connected to the read-out unit, which is preferentially an application specific integrated circuit (ASIC), preferentially by bump bonding or by an interposer-PCB (printed circuit board) or by a conductive rubber foil, on which the read-out unit is bonded.

It is further preferred that between the electrodes, which are coupled to the second surface of the second layer, recesses, grooves or slots are provided in the second surface of the second layer. This reduces possible electrical crosstalk.

It is further preferred, that the read-out unit is coupled to the light detection unit for reading out electrical signals generated by the light detection unit. Since the read-out unit is preferentially coupled to both, the light detection unit and the radiation quanta counting unit, for reading out electrical signals from both, the energy-resolving detection system can be constructed more compact and less complex, wherein, for example, module integration and interconnections are simplified. The light detection unit is preferentially read out through an integrating channel of the read-out unit. Furthermore, the read-out unit is preferentially coupled with the radiation quanta counting unit through counting channels, in particular through a pulse counting channel, in particular if the second layer comprises LYSO.

In a preferred embodiment, the second layer comprises a scintillator material for generating light signals depending on the radiation reaching the second layer, wherein the radiation quanta counting unit comprises a fast light detection unit for detecting the light signals generated in the second layer, wherein the read-out unit is coupled with the fast light detection unit for reading out the fast light detection unit.

Since radiation reaching the second layer has been partly absorbed by passing the first layer, the intensity of the radiation reaching the second layer has been reduced, diminishing the effect of superposition of several radiation quanta and, thus increasing the energy-resolution of the energy-resolving detection system. The scintillator material of the second layer and the fast light detection unit have preferentially a bandwidth allowing single radiation quanta counting. The fast light detection unit is preferentially read out through a counting channel, and the read-out unit is preferentially adapted for assigning to each radiation quantum an energy window and for counting the radiation quanta within each energy window.

In a preferred embodiment, the scintillator material of the second layer is adapted for registering single radiation quanta, in particular single X-ray radiation quanta. It is further preferred that the fast light detection unit is adapted for distinguishing between the light pulses induced by single radiation quanta. This allows detecting single radiation quanta, for example, single X-ray photons, which further improves the energy resolution of the energy-resolving detection system.

It is further preferred, that the energy-resolving detection system comprises an arrangement of a plurality of detection pixel units, wherein each detection pixel unit comprises
a separate first layer for absorbing a part of the radiation,
a separate radiation quanta counting unit comprising a second layer for counting radiation quanta of the radiation,
   wherein the first layer and the second layer of each detection pixel unit are arranged such that the radiation, which is incident on the detection system and which reaches the second layer, has passed the first layer,
   wherein the read-out unit is coupled to the radiation quanta counting unit of each detection pixel unit for reading out the separate radiation quanta counting units of the multiple of detection pixel units independently from each other. This allows detecting radiation along a region covered by the arrangement of the multiple of detection pixel units energy-resolved and spatially resolved.

In a further aspect of the invention an imaging system is provided, which comprises the energy-resolving system in accordance with the invention.

In a further aspect of the invention a method for producing an energy-resolving detection system for detecting radiation is provided, wherein the method comprises following steps:

providing a first layer for absorbing a part of the radiation,

providing a radiation quanta counting unit comprising a second layer for counting radiation quanta of the radiation,

providing a read-out unit for reading out the radiation quanta counting unit,

arranging the first layer and the second layer such that the radiation, which is incident on the detection system and which reaches the second layer, has passed the first layer,

coupling the read-out unit with the radiation quanta counting unit for reading out the radiation quanta counting unit.

The first layer can comprise a converting material, for example a scintillation material, for converting a part of the radiation into photons, which are detectable by a light detection unit.

It shall be understood, that the energy-resolving detection system of claim 1, the imaging system of claim 10, and the method for producing an energy-resolving detection system for detecting radiation of claim 11 have similar and/or identical preferred embodiments as defined in the dependent claims.

### BRIEF DESCRIPTION OF THE DRAWINGS

These and other aspects of the invention will be apparent from and elucidated with reference to the embodiments described hereinafter. In the following drawings:

FIG. 1 shows schematically a representation of an imaging system in accordance with the invention comprising an energy-resolving detection system in accordance with the invention,

FIG. 2 shows schematically a representation of a detection pixel unit of the energy-resolving detection system in accordance with the invention,

FIG. 3 shows schematically a flowchart illustrating an imaging method for imaging a region of interest in accordance with the invention,

FIG. 4 shows schematically a flowchart illustrating a method for producing an energy-resolving detection system for detecting radiation in accordance with the invention,

FIG. 5 shows schematically a representation of a detection pixel unit of an energy-resolving detection system in accordance with the invention and

FIG. 6 shows schematically a flowchart illustrating a method for producing an energy-resolving detection system for detecting radiation in accordance with the invention.

### DETAILED DESCRIPTION OF EMBODIMENTS

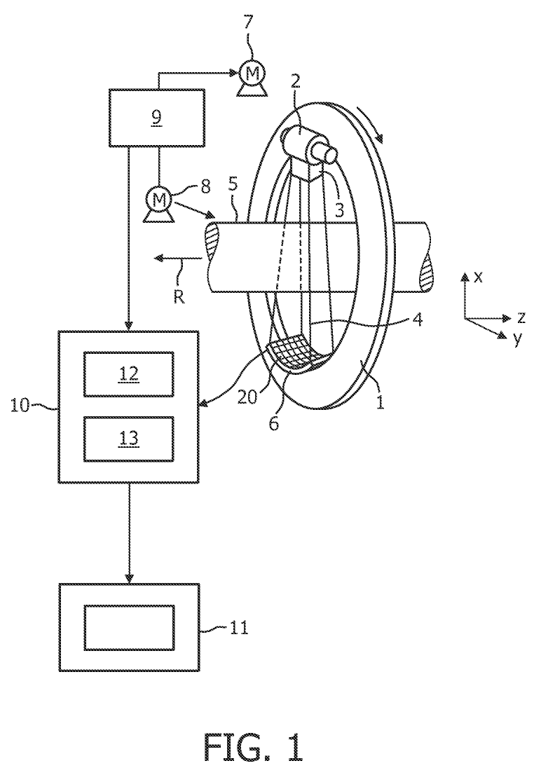

The imaging system shown in FIG. 1 is a spectral computed tomography system (spectral CT system). The spectral CT system includes a gantry 1 which is capable of rotation about an axis of rotation R which extends parallel to the z direction. A polychromatic radiation source 2, which is in this embodiment an X-ray source 2 emitting polychromatic X-ray radiation (bremsstrahlung spectrum with characteristic lines), is mounted on the gantry 1. The X-ray source 2 is provided with a collimator device 3, which forms in this embodiment a conical radiation beam 4 from the radiation produced by the X-ray source 2. The radiation traverses an object (not shown), such as a patient, in a region of interest in an examination zone 5, which is in this embodiment cylindrical. After having traversed the examination zone 5, the X-ray beam 4 is incident on an energy-resolving detection system 6, which comprises in this embodiment a two-dimensional detection surface. The energy-resolving detection system 6 is mounted on the gantry 1. The X-ray source 2 and the energy-resolving detection system 6 form a radiation-and-detection system for generating a plurality of energy-dependent detection signals.

The imaging system comprises a driving device having two motors 7, 8. The gantry 1 is driven at a preferably constant but adjustable angular speed by the motor 7. The motor 8 is provided for displacing the object, for example, a patient, who is arranged on a patient table in the examination zone 5, parallel to the direction of the axis of rotation R or the z axis. These motors 7, 8 are controlled by a control unit 9, for instance, such that the radiation source 2 and the examination zone 5 move relative to each other along a helical trajectory. However, it is also possible that the object or the examination zone 5 is not moved, but that only X-ray source 2 is rotated, i.e., that the radiation source 2 moves along a circular trajectory relative to the examination zone 5 or the object. Furthermore, in another embodiment, the collimator device 3 can be adapted for forming a fan beam and the energy-resolving detection system 6 can also be a one-dimensional detector.

The data acquired by the energy-resolving detection system 6 are provided to an image generation device 10 for generating an image of a region of interest, which is located in the examination zone 5, wherein the region of interest preferentially contains an object or a part of an object. The image generation device 10 comprises a calculation unit 12 for determining at least one attenuation component, which is, for example, a Compton effect component, a photo-electric effect component or a K-edge component of a material within the region of interest, and a reconstruction unit 13 for reconstructing an image of the region of interest using at least one of the determined one or more attenuation components.

The reconstructed image can finally be provided to a display 11 for displaying the image. Also the image generation device 10 is preferably controlled by the control unit 9.

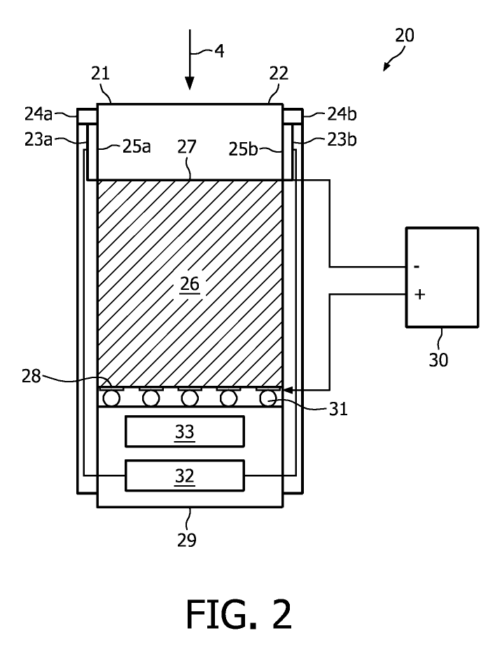

The energy-resolving detection system 6 comprises an arrangement of a plurality of detection pixel units 20. A representation of one of these detection pixel units 20 is schematically shown in FIG. 2.

The detection pixel unit 20 comprises a first layer 21, which is arranged such that the radiation 4 of the radiation unit 2 impinges on a surface 22 of the first layer 21. This surface 22 is preferentially a coating layer of high reflectivity (e.g. titanium dioxide) to prevent scintillator photons from leaving the bulk material. The first layer 21 is made of a scintillator material, which is, in this embodiment, gadolinium oxide sulphide (GOS:Pr). On the side faces of the first layer light detection units 23a, 23b are located for detecting light generated in the first layer 21. The detection pixel unit 20 comprising the first layer 21 has substantially the shape of a cuboid, wherein the light detection units 23a, 23b are arranged on side faces of the first layer 21, which are opposed to each other In this embodiment, two light detection units 23a, 23b are present, which are located on side faces of the first layer 21, which are opposed to each other. In another embodiment, also three or four light detection units can be arranged on three or four side faces of the first layer 21. The light emitting units 23a, 23b are preferentially photodiodes. The photodiodes are preferentially very thin, i.e. their thickness is preferentially smaller than 100 μm, further preferred smaller than 50 μm, further preferred smaller than 30 μm, and it is further preferred that the thickness is smaller than 20 μm.

The light emitting units 23a, 23b are preferentially fixed by a holding element, which is, for example, a metal plate or a metal rod, which holds the light emitting units 23a, 23b such that they sense the light generated in the first layer 21 from the side, i.e. perpendicular to the direction of incidence.

Each light detection unit 23a, 23b comprises a light detection surface 25a, 25b, which is arranged substantially parallel to the direction of incidence of the radiation 4, in order to reduce the amount of direct conversion in the light detection units 23a, 23b. Furthermore, the detection pixel unit 20 comprises shields 24a, 24b for reducing direct hits in the light detection units 23a, 23b by radiation incident on the detection pixel unit 20, in order to reduce a direct influence of the light detection units 23a, 23b by the radiation 4. The shields 24a, 24b are located on the sides of the light detection units 23a, 23b, which face the radiation 4 incident on the energy-resolving detection system 20. The shields 24a, 24b are made of a metal having a high atomic number, which is preferentially larger than 30. The shields 24a, 24b are preferentially made of at least of one of tungsten, lead and molybdenum.

The detection pixel unit 20 further comprises a second layer 26, wherein the first layer 21 and the second layer 26 are arranged such that the radiation 4, which is incident on the detection pixel unit 20 and which reaches the second layer 26, has passed the first layer 21. The first layer 21 and the second layer 26 are arranged adjacent to each other, wherein preferentially an electrode 27 is located between them. The electrode 27 is preferentially dimensioned such that it covers the whole region between the first layer 21 and the second layer 26. The second layer 26 forms, in this embodiment, a radiation quanta counting unit and comprises a direct-conversion material, which is preferentially cadmium zinc telluride (CZT) or a CdTe-type material. The electrode 27 is preferentially a metal electrode, wherein the electrode 27 comprises preferentially platinum having preferentially a thickness of 100 nm. The electrode 27 is contacted with the first surface of the second layer 26, which faces the first layer 21.

In addition, the surface of this metal electrode layer is preferentially covered with a coating material of a high reflectivity (e.g. titanium dioxide) to optimally reflect optical photons back into the GOS bulk material.

The radiation, which reaches the second layer 26 is converted into electrical signals, i.e. into electrons, which are read out by a read-out unit 29. The read-out unit 29 comprises electrodes 28, which are contacted with a second surface of the second layer 26, which is opposed to the first surface of the second layer 26. The electrodes 27, 28 are preferentially made of the same material. The electrodes 27, 28 are connected to a voltage unit 30 such that electrons generated in the second layer 26 are forced to the electrodes 28 for collecting them. The electrodes 28 are connected to the read-out unit 29, which is, in this embodiment, an ASIC, via bumps 31 by bump bonding. The read-out unit 29 comprises an integrating channel 32 and counting channels 33. The integrating channel 32 is connected to the light detection units 23a, 23b for reading out the light detection units 23a, 23b in an integrating mode. The counting channels 33 are connected to the electrodes 28 via the bumps 31 for reading out the electrical signals generated in the second layer in a single-photon counting mode with energy information. In another embodiment, the read-out unit 29 does only readout the electrical signals generated in the second layer 26, in particular, by using an ASIC, and the light detection units 23a, 23b are readout by another dedicated ASIC, like the TACH. Between the electrodes 28 preferentially recesses, grooves or slots are provided in the second surface of the first layer 26. These recesses, grooves or slots reduce possible crosstalk effects.

The TACH is, for example, described in “A new 2D-tiled detector for multislice CT”; Luhta, Randy; Chappo, Marc; Harwood, Brain; Mattson, Rod; Salk, Dave; Vrettos, Chris; Medical Imaging 2006: Physics of Medical Imaging. Edited by Flynn, Michael J.; Hsieh, Jiang; Proceedings of the SPIE, Volume 6142, pp. 275-286 (2006), which is herewith incorporated by reference.

The read-out unit 29 comprises different energy thresholds, which can also be named as energy windows, and the read-out unit 29 is adapted such that it counts the photons, which have reached the second layer 26, for each energy window, i.e. for each energy window the read-out unit 29 provides the number of photons within the respective energy window. The read-out unit 29 generates for each energy window a detection signal, which depends on the number of photons in the respective energy window. Furthermore, the detection signals generated by the light detection units 23a, 23b correspond to the overall number of photons with a distinct energy distribution, which is defined by the scintillator material of the first layer 21. These detection signals are the data, which are transferred to the image generations device 10 for generating an image of a region of interest.

The electrodes 28 are preferentially rectangular metal plates having a side length of, for example, 0.2 mm. The electrodes 28 are preferentially arranged matrix-like in a planar rectangular arrangement. For example, one detection pixel unit 20 can comprise 5×5 electrodes 28, wherein each electrode has a dimension of 0.2×0.2 mm.

The first layer 21 has preferentially a thickness in the range of 0.4 mm to 0.8 mm, further preferred in the range of 0.5 mm to 0.7 mm, and preferentially a thickness of 0.6 mm. The second layer has preferentially a thickness in the range of 1.8 mm to 2.2 mm, further preferred in the range of 1.9 mm to 2.1 mm, and it is further preferred that the second layer 26 has a thickness of 2.0 mm. For each electrode 28, which can also be regarded as sub-pixel, several counting channels for different energy windows are implemented in the read-out unit 29, i.e. for each electrode 28 several counting channels are provided, wherein each counting channel of an electrode 28 counts photons of a certain energy window. Preferentially, for each electrode 28 four counting channels are provided.

This embodiment and the below described embodiment of an energy-resolving detection system comprise a high count rate capability.

The detection signals of the counting channels 33 and of the integrating channel 32 are transmitted to the image generation device 10 for generating an image of the region of interest. For this reconstruction, the calculation unit 12 determines from these detection signals different attenuation components, which represent, for example, the absorption properties of different materials within the region of interest, and/or a Compton effect component and/or a photo-electric effect component and/or a K-edge component. At least one of these attenuation components is transmitted to the reconstruction unit 13, which reconstructs an image of the region of interest, using at least one of the determined attenuation components. Preferentially, the reconstruction unit 13 uses only one attenuation component for reconstructing an image of the region of interest. Such an image is not disturbed by the influence of other effects, which correspond to the other determined attenuation components, resulting in an image of the region of interest with reduced artefacts and improved quality.

The determination of the attenuation components by the calculation unit 12 is known, for example, from “Energy-selective reconstructions in X-ray Computerized Tomography”, R. E. Alvarez, A. Macovski, Phys. Med. Biol., 1976, Vol. 21, No. 5, 733-744. Since the region of interest has been illuminated by the radiation 4 from different directions and since for each of these directions at least one attenuation component has been determined, the reconstruction unit 13 can use standard computed tomography reconstruction techniques, like a filtered backprojection for reconstructing an image of the region of interest.

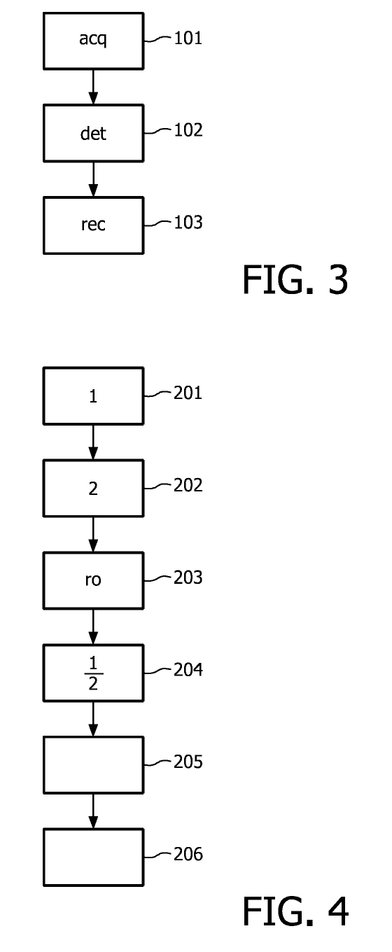

In the following a method for imaging the region of interest will be described with reference to a flowchart shown in FIG. 3.

In step 101, the X-ray source 2 rotates around the axis of rotation R or the z direction, and the object is not moved, i.e. the X-ray source 2 travels along a circular trajectory around the object. In another embodiment, the X-ray source 2 can move along another trajectory, for example, a helical trajectory, relative to the object. The X-ray source 2 emits polychromatic X-ray radiation traversing the object at least in a region of interest. The object is, for example, a human heart of a patient, wherein a contrast agent, like an iodine or gadolinium based contrast agent, which have K edges within the range of primary x-ray energies, has preferentially been injected in advance. The X-ray radiation 4, which has passed the object and preferentially the substance within the object, is detected by the energy-resolving detection system 6, which generates energy-resolved detection signals.

In step 102, the calculation unit 12 determines at least one attenuation component, which is, in this embodiment, preferentially the K-edge component of the contrast agent within the object. Alternatively or in addition, other attenuation components can be determined by the calculation unit 12, like a Compton effect component, a photoelectric effect component or K-edge components of different materials within the region of interest.

In step 103, the reconstruction unit 13 generates an image of the region of interest, using preferentially the determined K-edge component of the contrast agent. Alternatively or in addition, an image can be reconstructed using one of the other in step 102 determined attenuation components.

The reconstructed images are, for example, free of beam hardening effects and can, thus, be analyzed quantitatively. Furthermore, the images provide a material decomposition and comprise a contrast-to-noise ratio, which is larger than the contrast-to-noise ratio of images reconstructed by known computed tomography systems.

A method for producing an energy-resolving detection system for detecting radiation will now be described with reference to a flowchart shown in FIG. 4.

In step 201, a first layer 21 is provided for absorbing a part of the radiation. In step 202, a second layer 26 being, in this embodiment, a radiation quanta counting unit and comprising a direct-conversion material for directly converting radiation into electrical signals is provided, and in step 203 a read-out unit 29 for reading out the electrical signals of the second layer is provided. In step 204, the first layer 21 and the second layer 26 are arranged such that the radiation, which is incident on the detection system and which reaches the second layer 26, has passed the first layer. The read-out unit 29 is coupled with second layers 26 for reading out the electrical signals of the second layer 26 preferentially by bump bonding in step 205.

Steps 201 to 205 are preferentially performed for each detection pixel unit, and in step 206 these detection pixel units are assembled to an arrangement of a plurality of detection pixel units.

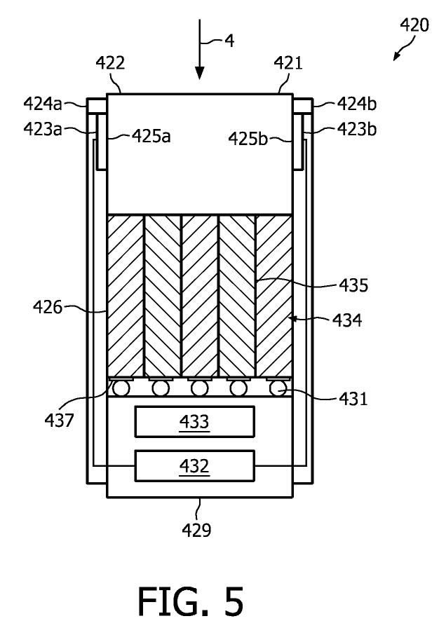

In another embodiment, the energy-resolving detection system can comprise an arrangement of other embodiments of a detection pixel unit. A representation of one of these other embodiments of a detection pixel unit 420 is schematically shown in FIG. 5.

The detection pixel unit 420 comprises a first layer 421, which is arranged such that the radiation 4 of the radiation unit 2 impinges on a surface 422 of the first layer 421. The first layer 421 absorbs a part of the radiation 4 and is a scintillator material, which is, in this embodiment, GOS. On the side faces of the first layer light detection units 423a, 423b are located for detecting light generated in the first layer 421. Each light detection unit 423a, 423b comprises a light detection surface 425a, 425b, which is arranged substantially parallel to the direction of incidence of the radiation 4, in order to reduce a direct conversion in the light detection unit 423a, 423b. Furthermore, the detection pixel unit 420 comprises shields 424a, 424b for reducing direct hits in the light detection units 423a, 423b by radiation incident on the detection pixel unit 420, in order to reduce a direct influence of the light detection units 423a, 423b by the radiation 4. Since the first layer 421, the light detection units 423a, 423b and the shields 424a, 424b correspond to the first layer 21, the light detection units 23a, 23b and the shields 424a, 424b of the detection pixel unit 20 shown in FIG. 2, respectively, for a more detailed description of these parts of the detection pixel unit 420 reference is made to the description of the corresponding parts of the detection pixel unit 20.

The detection pixel unit 420 further comprises a second layer 426, wherein the first layer 421 and the second layer 426 are arranged such that the radiation 4, which is incident on the detection pixel unit 420 and which reaches the second layer 426, has passed the first layer 421. The first layer 421 and the second layer 426 are arranged adjacent to each other. The second layer 426 comprises a scintillator material, in particular a fast scintillator material. A fast scintillator material is a scintillator material, which allows single-quanta counting. A fast scintillator material is, for example, a lutetium oxyortho silicate (LSO) or LYSO (lutetium yttrium oxyortho silicate).

The second layer 426 is segmented into several segments 434, wherein each segment 434 of the second layer 426 is optically shielded to the other segments 434 of the second layer 426 by optical shields 435, in order to prevent optical cross talk. The optical shields 435 are preferentially metal plates which are preferably coated with highly reflecting material (e.g. titanium dioxide). Each segment 434 is optically coupled to a fast photodiode 437. A fast photodiode is a photodiode, which allows together with the second layer 426 preferentially single-quanta counting. The fast photodiode has preferentially a bandwidth larger than 10 MHz. The second layer and the fast photodiodes form, in this embodiment, a radiation quanta counting unit. The fast photodiodes 437 are coupled to counting channels 433 of a read-out unit 429 in this embodiment via bumps 431. The read-out unit 429 further comprises an integrating channel 432. The read-out unit 429 and its different parts correspond to the read-out unit 29 and its different parts described above with reference to FIG. 2, in particular the read-out unit provides at least two energy windows and is adapted for counting the radiation quanta in each energy window. For a more detailed description of the read-out unit 429, it is therefore referred to the above mentioned description.

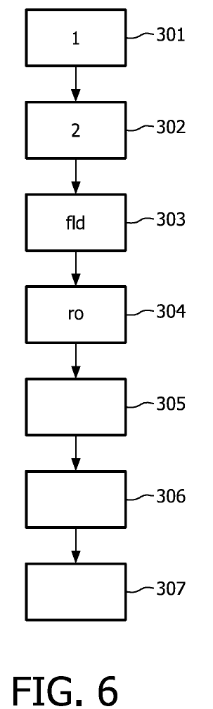

In the following a method for producing an energy-resolving detection system for detecting radiation in accordance with the invention we will be described with reference to a flowchart shown in FIG. 6.

In step 301, a first layer for absorbing a part of the radiation, which comprises preferentially a scintillation material, is provided, in step 302 a second layer is provided, which comprises a scintillator material generating light signals depending on the radiation reaching the second layer, wherein the scintillator material of the second layer is preferentially segmented, and in step 303 a fast light detection unit for detecting the light signals generated in the second layer is provided. The second layer and the fast light detection unit form, in this embodiment, a radiation quanta counting unit, i.e. steps 302 and 303 can be combined to a single step of providing a radiation quanta counting unit. The provided scintillator material of the second layer and the fast light detection unit are preferentially adapted such that they allow single-radiation-quanta counting. Furthermore, in step 304, a read-out unit is provided for reading out the fast light detection unit

In step 305 the first layer and the second layer are arranged such that the radiation, which is incident on the detection system and which reaches the second layer has passed the first layer, and in step 306, the read-out unit is coupled with the fast light detection unit for reading out the fast light detection unit preferentially such that each detected radiation quantum is assigned to an energy window and such that the number of radiation quanta in each energy window is counted, wherein the distribution of the numbers of radiation quanta in the different energy windows is provided as energy-resolved detection signals.

Steps 301 to 306 are preferentially repeated several times to produce several detection pixel units, in particular, for producing several detection pixel units 420, and in step 307 these detection pixel units are assembled to an arrangement of a plurality of detection pixel units of the energy resolving detection system.

Although in the above described embodiment, preferentially a contrast agent has been injected into the object, images of a region of interest can also be reconstructed, if a contrast agent is not present within the region of interest. Furthermore, although in the above described embodiment the object is preferentially a human heart of a patient, the imaging system can also be used to reconstruct images of technical objects, and the energy-resolving detection system can also be used to detect radiation after having passed a technical object. The invention can, for example, be used in the fields of non-destructive testing, baggage inspection or industrial quality control.

Although in the above described embodiment the first layer comprises a scintillator material, the first layer can also comprise another material, which absorbs a part of the incident radiation. For example, also the first layer can comprise a direct-conversion material or other materials, which can be used for detecting also the radiation absorbed in the first layer.

Although in the above described embodiments the light detection units coupled to the first layer are arranged for detecting light generated in the first layer in a direction perpendicular to a direction of incidence of the radiation, i.e. the light detection units have been described as being arranged on side faces of the first layer, the light detection units for detecting light within the first layer can also be located between the first layer and the second layer, i.e. in the orientation shown in FIGS. 2 and 5 in a horizontal plane. In this case, this horizontal light detection unit is preferentially extremely thin, in order to reduce direct conversion within the light detection unit, i.e. the thickness is preferentially smaller than 100 μm, further preferred smaller than 50 μm, and further preferred smaller than 20 μm.

Although, special attenuation components have been mentioned above, arbitrary attenuation components can be used, which constitute the attenuation of an object, which has to be reconstructed. At least two base functions together with at least two energy bins or energy windows can be used for determining the attenuation components, wherein these at least two energy windows or energy bins can result from the combination of the second layer and the read-out unit only or from this combination and the combination of the first layer, the light detection unit and a corresponding integrating channel. The determined attenuation components are used for reconstruction. The determination of the at least one attenuation component and the following reconstruction can, for example, be performed by using the method described in “Basis Material Decomposition Using Triple—Energy X-ray computed tomography”, P. Sukovic et al., IEEE IMTC 1999, which is herewith incorporated by reference.

Other variations to the disclosed embodiment can be understood and effected by those skilled in the art in practicing the claimed invention, from a study of the drawing, the disclosure and the appended claims.

Further, processing of the spectral information can be processed by other means. For instance, reconstruction of each energy window and/or reconstruction of the signal of the first absorbing layer can already provide tomograms with enhanced contrast. Linear operations on theses tomograms, e.g., can further enhance the contrast-to-noise ratio. Similarly, linear and non-linear operations could be applied on the respective energy channels prior to reconstruction or after reconstruction.

In the claims, the word “comprising” does not exclude other elements or steps, and the indefinite article “a” or “an” does not exclude a plurality.

A single unit may fulfill the functions of several items recited in the claims. Furthermore, several functions described as being performed by a certain number of units, can be performed by more or less units, in particular, by one unit. The units can be implemented as computer programs and/or as dedicated hardware.

The mere fact, that certain measures are recited in mutually different dependent claims does not indicate, that a combination of these measures cannot be used to advantage.

A computer program may be stored/distributed on a suitable medium, such as an optical storage medium or a solid-state medium supplied together with or as part of other hardware, but may also be distributed in other forms, such as via the internet or other wired or wireless telecommunication systems.

Any reference sign in the claims should not be construed as limiting the scope.

1. An energy-resolving detection system for detecting radiation, the detection system comprising:
a first layer for absorbing a part of the radiation,
a radiation quanta counting unit comprising a second layer for counting radiation quanta of the radiation,
a read-out unit coupled with the radiation quanta counting unit for reading out the radiation quanta counting unit,
wherein the first layer and the second layer are arranged such that the radiation, which is incident on the detection system and which reaches the second layer, has passed the first layer.

2. The energy-resolving detection system as claimed in claim 1, wherein the second layer comprises a direct conversion material for converting radiation into electrical signals and
wherein the read-out unit is coupled with the second layer for reading out the second layer by reading out the electrical signals of the second layer.

3. The energy-resolving detection system as claimed in claim 1, wherein the first layer comprises a scintillator material and wherein the energy-resolving detection system further comprises a light detection unit for detecting light generated in the first layer.

4. The energy-resolving detection system as claimed in claim 3, wherein the light detection unit is arranged for detecting light generated in the first layer in a direction perpendicular to a direction of incidence of the radiation.

5. The energy-resolving detection system as claimed in claim 3, wherein the light detection unit is shielded for reducing direct detection of the radiation incident on the detection system by the light detection unit.

6. The energy-resolving detection system as claimed in claim 1, wherein a second surface of the second layer, which is opposed to a first surface of the second layer facing the first layer, is coupled to a plurality of electrodes, wherein each electrode is coupled with the read-out unit such that the electrodes can be read out independently from each other.

7. The energy-resolving detection system as claimed in claim 3, wherein the read-out unit is coupled to the light detection unit for reading out electrical signals generated by the light detection unit.

8. The energy-resolving detection system as claimed in claim 1, wherein the second layer comprises a scintillator material for generating light signals depending on the radiation reaching the second layer,
wherein the radiation quanta counting unit comprises a fast light detection unit for detecting the light signals generated in the second layer,
wherein the read-out unit is coupled with the fast light detection unit for reading out the fast light detection unit.

9. The energy-resolving detection system as claimed in claim 1, wherein the energy-resolving detection system comprises an arrangement of a plurality of detection pixel units, wherein each detection pixel unit comprises
a separate first layer for absorbing a part of the radiations,
a separate radiation quanta counting unit comprising a second layer; for counting radiation quanta of the radiation,
wherein the first layer and the second layer of each detection pixel unit are arranged such that the radiation, which is incident on the detection system and which reaches the second layer, has passed the first layer,
wherein the read-out unit is coupled to the radiation quanta counting unit of each detection pixel unit for reading out the separate radiation quanta counting units of the multiple of detection pixel units independently from each other.

10. An imaging system comprising the energy-resolving detection system defined in claim 1.

11. A method for producing an energy-resolving detection system for detecting radiation, the method comprising following steps:
providing a first layer for absorbing a part of the radiation,
providing a radiation quanta counting unit comprising a second layer for counting radiation quanta of the radiations,
providing a read-out unit for reading out the radiation quanta counting unit,
arranging the first layer and the second layer such that the radiations, which is incident on the detection system and which reaches the second layer, has passed the first layer,
coupling the read-out unit with the radiation quanta counting unit for reading out the radiation quanta counting unit.
